(19) United States
(12) Patent Application Publication
(10) Pub. No.: US 2016/0232946 A1
(43) Pub. Date: Aug. 11, 2016

(54) SELF-ASSEMBLED MONOLAYER COATING FOR DISC DRIVE MANUFACTURE

(71) Applicant: Seagate Technology LLC, Cupertino, CA (US)

(72) Inventors: Timothy Stoebe, Minnetonka, MN (US); David J. Ellison, Minneapolis, MN (US); Robert A. Fernandez, Bloomington, MN (US); John L. Brand, Burnsville, MN (US)

(21) Appl. No.: 14/617,731

(22) Filed: Feb. 9, 2015

(51) Int. Cl. G11B 33/14; G11B 5/10

(52) U.S. Cl. CPC G11B 33/1446; G11B 5/10

(57) ABSTRACT

A method of making a disc drive assembly comprising a plurality of components, the method comprising providing a self-assembled monolayer coating on at least one piece of process equipment that contacts at least one of the plurality of components. The self-assembled monolayer coating is not present in the assembled disc drive assembly.

### BACKGROUND

Hard disc drives are common information storage devices having a series of rotatable discs that are accessed by magnetic reading and writing elements. These data elements, commonly known as transducers, or merely as a transducer, are typically carried by and embedded in a slider that is held in a close relative position over discrete data tracks formed on a disc to permit a read or write operation to be carried out.

As distances between the slider and the disc decrease, due to the ever-growing desire to reduce the size of the disc drive and to pack more data per square inch, the potentially negative impact due to contamination on the slider increases. Unwanted contaminants on the slider can adversely affect fly height behavior, such as with elevated or decreased fly height, create fly asymmetry in roll or pitch character, produce excessive modulation, and even result in head-disc crashing or contact, all possibly due to contaminant build up on the slider. All of these mechanisms result in degraded performance of the read or write operation of the head (e.g., skip-writes, modulated writers, weak writes, clearance stability and settling, and incorrect clearance setting).

Contaminants can be introduced on to the slider and to other components of the disc drive during any number of manufacturing or processing steps. What is needed is a mechanism to remove and/or control contaminants from contaminating components of the disc drive.

### SUMMARY

One particular implementation described herein is a method of making a disc drive assembly comprising a plurality of components, the method comprising providing a self-assembled monolayer coating on at least one piece of process equipment that contacts at least one of the plurality of components.

Another particular implementation is a method comprising inhibiting contact transfer from a piece of process equipment to a component of a disc drive assembly by providing a self-assembled monolayer coating on the piece of process equipment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTIONS OF THE DRAWING

The described technology is best understood from the following Detailed Description describing various implementations read in connection with the accompanying drawings.

FIG. 1 is a top plan view of an example disc drive assembly.

FIG. 2 is a side view of a schematic example of a lapping process.

FIG. 3 is a perspective view of an example of a slider carrier tray.

FIG. 4 is a perspective view of an example head-gimbal assembly (HGA) carrier tray.

FIG. 5 is a perspective view of an example media carrier.

### DETAILED DESCRIPTION

As discussed above, hard disc drive assemblies include a slider that is designed and configured to glide on an air bearing over a magnetic data storage disc. Contaminants, on the slider, on the disc, or elsewhere in the disc drive assembly, can interfere with the proper performance of either or both the “read” operation and the “write” operation of the disc drive. Often, the source of the contaminants is a source external to the disc drive itself; the contaminants are introduced to the disc drive during the manufacturing process of the disc drive, typically by contact transfer from a piece of equipment used during the manufacturing and/or assembly process. Another source of contaminant is the piece of processing equipment or the drive component itself; abrasion between the drive component and the processing piece can readily result in particulate contaminants. The present disclosure describes providing a self-assembled monolayer (SAM) coating on at least one piece of process equipment that contacts at least one of the plurality of components of the disc drive during manufacture and/or assembly of the components. The self-assembled monolayer coating inhibits the transfer of any contaminants that might be on the piece of process equipment to the component, either by inhibiting the presence of the contaminant on the piece or by inhibiting release of the contaminant from the piece. The self-assembled monolayer coating, which is not found in the eventual assembled disc drive assembly, reduces contact transfer of contaminants during the manufacturing and/or assembly processes.

In the following description, reference is made to the accompanying drawing that forms a part hereof and in which are shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

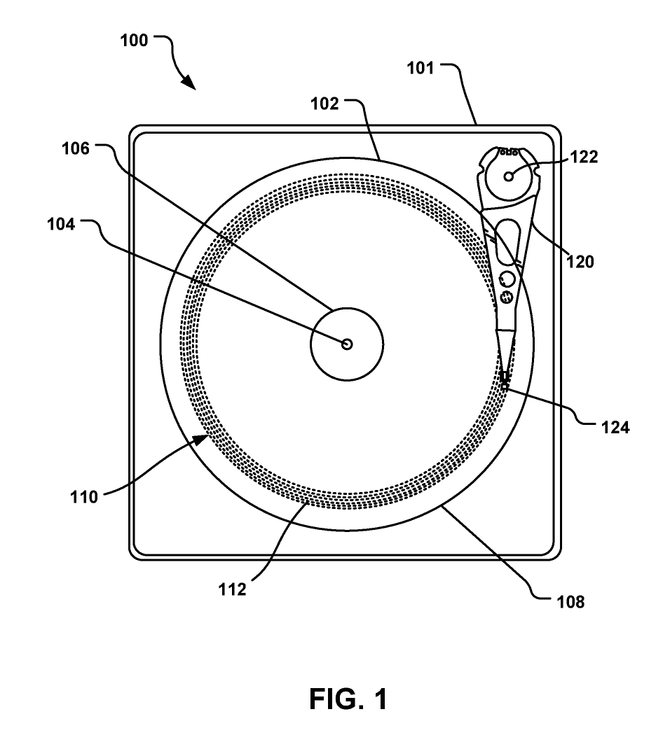

FIG. 1 illustrates a perspective view of an exemplary magnetic disc drive 100. Disc drive 100 includes a base and a top cover that combine to form a housing 101 in which is located one or more rotatable magnetic data storage media or discs 102. Disc 102 rotates about a spindle center or a disc axis of rotation 104 during operation. Disc 102 includes an inner diameter 106 and an outer diameter 108 between which are a number of concentric data tracks 110, illustrated by circular dashed lines. Data tracks 110 are substantially circular and are made up of regularly spaced bits 112, indicated as dots or ovals on disc 102. It should be understood, however, that the described technology may be employed with other types of storage media, including continuous magnetic media, discrete track (DT) media, etc.

Information may be written to and read from bits 112 on disc 102 in different data tracks 110. A head-gimbal assembly (HGA) 120 having an actuator axis of rotation 122 supports a slider 124 with a transducer in close proximity above the surface of disc 102 during disc operation. When a pack of multiple discs 102 is utilized, each disc 102 or medium surface has an associated slider 124 which is mounted adjacent to and in communication with its corresponding disc 102.

The surface of slider 124 closest to and opposite to disc 102 is called the air-bearing surface (ABS). In use, head-gimbal assembly 120 rotates during a seek operation about the actuator axis of rotation 122 to position slider 124 and head-gimbal assembly 120 over a target data track of data tracks 110. As disc 102 spins, a layer of air forms between slider 124 and the surface of disc 102, resulting in slider 124 ‘flying’ above disc 102. The transducer on slider 124 then reads or writes data to bits 112 in the target data track 110.

Each of the components of disc drive 100, components such as slider 124, head-gimbal assembly 120, disc 102, housing 101, etc., is individually formed and then assembled together to form disc drive 100. The total process to form disc drive 100 has hundreds of steps, virtually every process step being a potential source of contamination in the assembled disc drive 100.

If at least one of the pieces of the processing equipment that comes into contact with a component of disc drive 100 has a SAM coating thereon, contaminants in the assembled disc drive assembly are reduced, due to less or no contaminants being stuck on upstream processing equipment and thus in disc drive 100.

For example, slider 124 goes through a detailed process of forming (e.g., depositing) the various features of slider 124, cutting or slicing, and lapping to achieve the desired dimensions. After slider 124 is formed, it is washed and transported.

After forming (e.g., depositing) the various features of thousands of sliders 124 on a wafer, the wafer is cut or sliced into smaller pieces to facilitate further processing; in some implementations, the wafer is sliced in chunks, the chunks are sliced into bars, and after lapping, the bars are eventually sliced into individual sliders. Each of the slicing or cutting processes is a source of contaminants, both particular and chemical (e.g., cutting oil or solvent). Any or all of the process equipment that contacts (e.g., handles, slices, cuts) the wafer or its subparts (e.g., chunks, bars) can have a SAM coating thereon, to reduce the occurrence of contaminants in the assembled disc drive assembly, due to less or no contaminants being stuck on the wafer and thus upon the final slider.

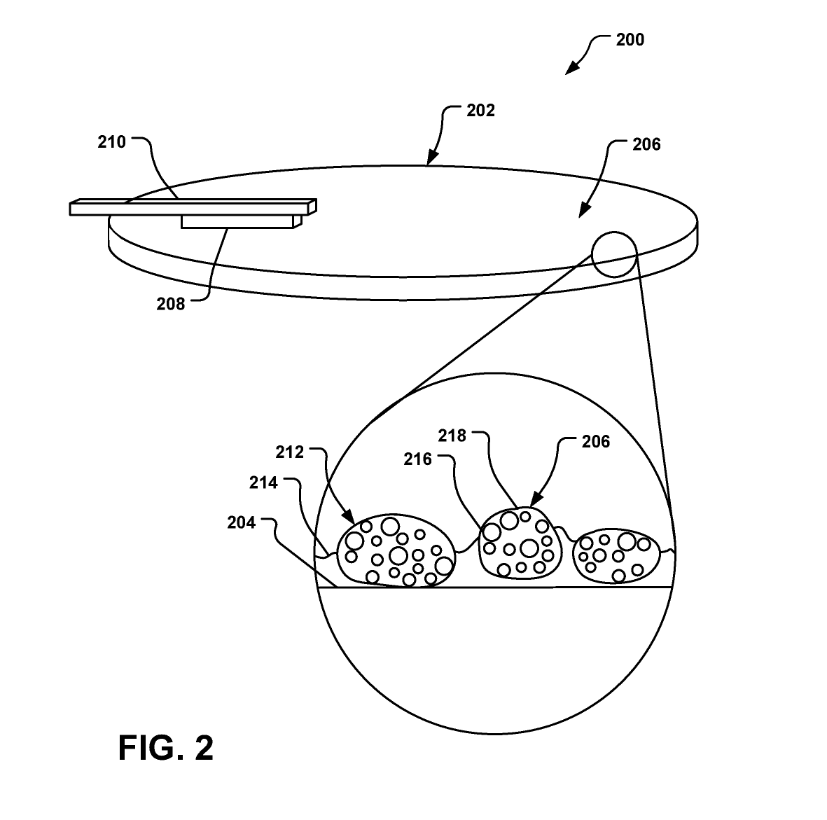

While in the bar stage, the bar is lapped (i.e., abraded) on a rotating lapping plate to provide a random motion of the slider bar over the lapping plate and randomize plate imperfections across the head surface. Some lapping plates have a non-abrasive horizontal working surface and are used in conjunction with a slurry of abrasive particles (e.g., diamonds), whereas other lapping plates have abrasive particles (e.g., diamonds) embedded in or on the horizontal working surface. FIG. 2 shows an example of a generic lapping system 200.

System 200 has a lapping plate or platen 202 having a working surface 204. Present on working surface 204 is an abrasive coating 206. A slider row bar 208 (cut from a wafer and containing a plurality of sliders) is held in contact with abrasive coating 206 by an arm assembly 210. In use, platen 202 is rotated relative to slider row bar 208 and bar 208 is held in pressing engagement against abrasive coating 206 by assembly 210. The abrading action of abrasive coating 206 removes material from slider bar 208 and provides the desired shape to the slider bar, which includes low crown effects, good stripe control, and good pitch.

For conventional lapping processes, the process includes three sequential steps: a rough lapping step, a fine lapping step, and a kiss lapping step. The rough lapping step, when as much as 20 microns of material might be removed from the slider bar, is an aggressive lapping process that requires good adhesion of the slider bar to the carrier tool in order to avoid a large twist being lapped into the bar. Conversely, the kiss lapping step is a final polishing and precision shaping step, much less aggressive than the rough lapping step, usually removing no more than 100 nanometers of material.

Turning to the inset of FIG. 2, abrasive coating 206 is present on working surface 204. Abrasive coating 206 has a plurality of abrasive composites 212 held on to working surface 204 by an adhesive 214. Each abrasive composite 212 has abrasive particles 216 retained in a matrix 218. For a rough lapping step, abrasive particles 216 (e.g., diamonds) are usually about 1 to about 5 micrometers in size, in some implementations as large as 10 micrometers; for a fine lapping step, abrasive particles 216 are usually about 0.1 to about 1 micrometer in size; for a kiss lapping step, abrasive particles 216 are usually less than 0.1 micrometer (100 nm). It is not uncommon for abrasive composites 212 to crack or break, releasing abrasive particles 216 and/or pieces of matrix 218. These contaminants may stick, e.g., by van der Waals or other weak forces, to the bar and eventual sliders.

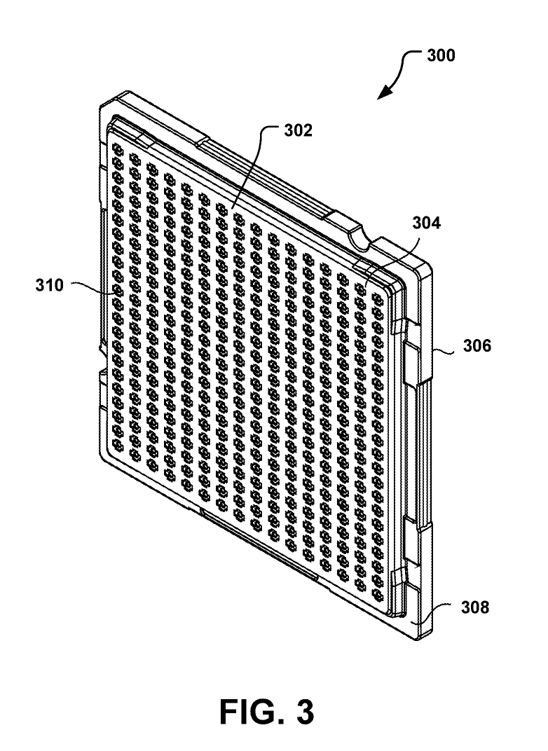

After formed, individual sliders are placed and stored in trays, such as tray 300 of FIG. 3; the sliders are also washed, to remove contaminants from the forming, slicing, and lapping processes. The particular tray 300 of FIG. 3 is suitable both as a cleaning tray and as a carrier tray, although in other implementations different trays are used for washing than storage. Tray 300 can be a plastic (polymeric) or plastic-coated device.

Tray 300 has a planar body 302 forming a central section having a top surface 304 and an opposite bottom surface (not seen), body 302 having an outer perimeter 306 and a perimeter flange 308. Top surface 304 has a plurality of cavities 310 therein, each for receiving a slider therein. Cavities 310 have dimensions selected to obtain adequate retention of the slider in cavity 310 during the cleansing process and/or the transport process.

From tray 300, the sliders are attached to a head-gimbal assembly and then assembled into a disc drive. Until the sliders are assembled into the disc drive, they come into contact with one or more trays, wash and rinse solutions and brushes that are used to wash and rinse hundreds of sliders, vacuum and/or end effectors that move the trays, tweezers, clamps, slider tray carriers, and other pick-up instruments that physically move the sliders.

If tray 300, or any of the pieces of the processing equipment (e.g., tweezers, etc.) that comes into contact with the slider, has a SAM coating thereon, contaminants in the assembled disc drive assembly are reduced, due to less or no contaminants being stuck on upstream processing equipment and thus upon the slider.

The various other components of the disc drive also undergo multi-step processing prior to being assembled into a disc drive. For example, the head-gimbal assembly (e.g., head-gimbal assembly 120 of FIG. 1) is formed, e.g., punched or stamped from a metal sheet and then bent to the desired configuration, and then placed into a tray for storage and/or cleansing. In some implementations, the head-gimbal assembly is formed from multiple components; for example, a head-gimbal assembly includes a load beam, a gimbal limiter, a piezoelectric (PZT) member, and electronics. During forming and after, the various components of the head-gimbal assembly are contacted by molds, brakes, end effectors, tweezers, clamps, and other pick-up instruments.

A slider is operably and electrically attached to the actuator assembly after the components have been formed. The slider, head-gimbal assembly (often alternately referred to a head-gimbal suspension assembly), and load beam, with other components, may be first placed in a ‘precising nest’ or other jig that accurately places and aligns the various components. The slider is particularly susceptible to contact transfer of contaminants when inserted into the precising nest (e.g., a small, stainless steel cavity) and held against registration surfaces. Once the slider is properly positioned, adhesive is dropped on the back of the slider, and the gimbal-suspension assembly is placed on and adhered to the slider. Such a process of inserting the slider into a cavity and pushing it against the reference surfaces is very susceptible to contamination contact transfer.

If the precising nest or other jig, or any other piece of processing equipment (e.g., tweezers, etc.) that comes into contact with the slider, head-gimbal assembly, etc. has a SAM coating thereon, contaminants in the assembled disc drive assembly are reduced.

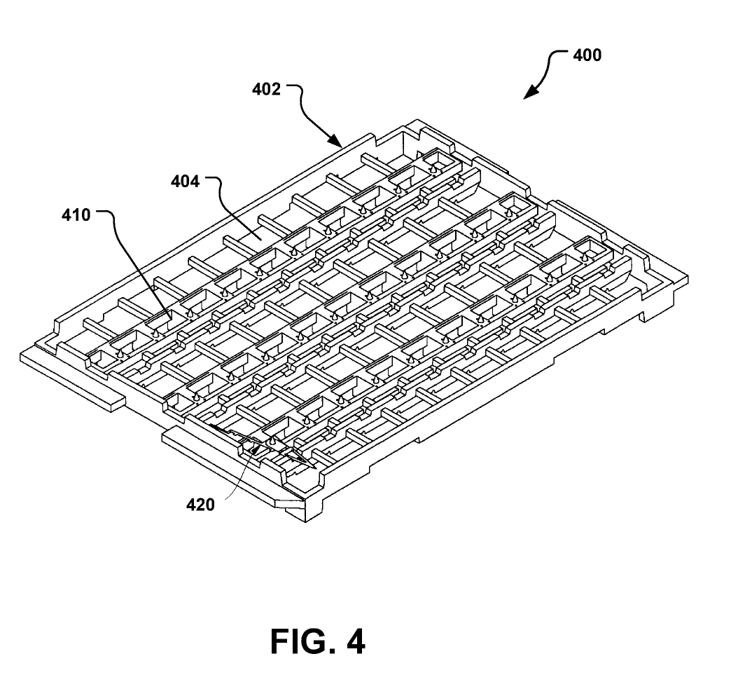

FIG. 4 illustrates a carrier tray 400 for a plurality of assembled head-gimbal assemblies (HGAs). Tray 400 has a body 402 having a top surface 404 and an opposite bottom surface (not seen). Top surface 404 has a plurality of cavities 410 therein, each for receiving an HGA therein; an HGA 420 is illustrated in one of the cavities. Cavities 410 have dimensions selected to obtain adequate retention of HGA 420 in cavity 410 during any storage process and transport process. Once assembled, HGA 420 often undergoes a quality test, to confirm, e.g., proper electrical connections.

If tray 400 or any of the pieces of the processing equipment (e.g., tweezers, testing equipment, etc.) that comes into contact with HGA 420 has a SAM coating thereon, contaminants in the assembled disc drive assembly are reduced.

The magnetic media or disc (e.g., disc 102 of FIG. 1) also undergoes multiple operations and movements before being installed into the disc drive. Generally, a metal or ceramic disc blank is coated with magnetic material; such process involves several handling operations, including moving the disc into the coating apparatus and out from the coating apparatus. Often, a hard protective overcoat (e.g., diamond-like carbon) is applied over the magnetic material, which also involves several handling operations. In each of the handling operations, the disc is susceptible to contact transfer of contaminants. In some methods, the disc is contacted by end effectors or other pick-up instruments and is carried and/or stored in media trays or media carriers.

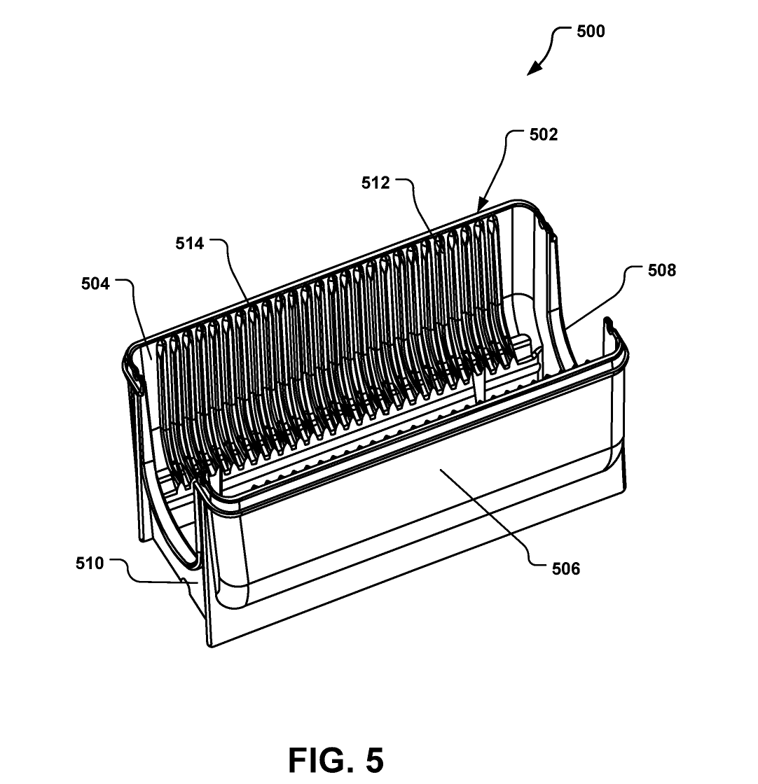

At various stages in the process, the media or disc is placed into a tray or carrier. FIG. 5 illustrates an example of a media carrier 500. Such a carrier 500 may be used for storing and/or for transporting a plurality of discs. The particular carrier 500 has a body 502 with opposite side walls 504, 506 and opposing end walls 508, 510. Spaced along side walls 504, 506 and projecting inward are ridges 512 that define slots 514, each for receiving a disc therein. The two side walls 504, 506 have an inwardly converging bottom portions that correspond to the shape of the disc. Carrier 500 may include a cover (not shown).

If carrier 500 or any of the pieces of the processing equipment (e.g., clamps, etc.) that comes into contact with the media has a SAM coating thereon, contaminants in the assembled disc drive assembly are reduced.

The disc drive assembly includes numerous other components such as, e.g., a spindle or shaft that supports the magnetic discs, a voice coil or other motor that moves the actuator assembly to align the slider on the data tracks, a housing or cover over the voice coil motor, flexible electronics that connect the slider to a processor via the actuator assembly, one or more filters, and the housing that encases all the disc drive components.

Any self-assembled monolayer (SAM) coating or coatings can be applied to the processing equipment. The coating is comprised of at least one SAM material and can be either a high surface energy coating or a low surface energy coating. The coating can be oleophobic or oleophilic, hydrophobic or hydrophilic. The SAM coating inhibits the contact transfer of any contaminants that might be on a piece of process equipment to the component that will eventually be found in the assembled disc drive assembly. In some implementations, the SAM coating inhibits the presence of contaminant on the piece of process equipment; that is, contaminant is less likely to stick or attach to the piece of process equipment. In other implementations, the SAM coating inhibits release of the contaminant from the piece of process equipment; that is, contaminant is less likely to release from the piece of process equipment and be transferred to the disc drive component.

A SAM coating is most beneficial on plastic (polymeric) processing equipment, as those pieces have a greater tendency to attract and retain contaminants thereon, contaminants that can then be transferred to the disc drive components. However, a SAM coating on metal, ceramic, composite processing equipment will also benefit the reduction of contaminants on the disc drive components. Both plastic and metal may have surface pores, which the SAM coating may seal, thus eliminating possible locations for contaminants to reside.

In some implementations, a SAM coating reduces contaminants by inhibiting the creation of contaminants. For example, a SAM coating on the bottom wall of a cavity of a slider carrier tray (e.g., cavity 310 of tray 300, of FIG. 3) may increase or decrease the friction between the slider and the cavity, depending on the material of the slider, the material of the tray, and the SAM used. A SAM can be selected to increase the friction between the slider and the tray, thus inhibiting the slider from sliding within the cavity, and thus reducing the possibility of abrading the cavity and/or the slider and releasing contaminants. Alternately, a SAM can be selected to decrease the friction between the slider and the tray, thus facilitating easy movement of the slider within the cavity, and thus reducing the possibility of abrading the cavity and/or the slider and releasing contaminants. In a similar manner, a SAM coating can be applied to any surface of a cavity of an HGA tray (e.g., cavity 410 of tray 400, of FIG. 4).

The terms “self-assembled monolayer,” “SAM,” and variants thereof, refer to a thin monolayer of surface-active molecules provided (e.g., adsorbed and/or chemisorbed) on a surface to produce chemical bonds therebetween. The molecules may have been present, for example, in a reaction solution or a reactive gas phase.

The term “low surface energy” and variations thereof, as used herein, refers to the tendency of a surface to resist wetting (high contact angle) or adsorption by other unwanted materials or solutions. In a low surface energy SAM, the functional terminal groups of the molecules are chosen to result in weak physical forces (e.g., Van der Waals forces) between the coating and contaminant. A low surface energy SAM allows for partial wetting or no wetting of the resulting SAM coating (i.e., a high contact angle between a liquid and the coating). Conversely, “high surface energy” refers to the tendency of a surface to increase or promote wetting (low contact angle) or adsorption of the surface of contaminants. In a high surface energy SAM, the functional terminal groups of molecules are chosen to result in a stronger molecular force between the coating and contaminant. If both a high surface energy coating and a low surface energy coating are present, the surface energies are relative. Values that are typically representative of “low surface energy” are in the range of 5-30 dyne/cm and high surface energy materials are relatively higher than this range, typically anything greater than 30 dyne/cm.

The phrase “oleophilic SAM” and variations thereof as used herein refers to a SAM having an oleophilic functional end group, such as saturated hydrocarbons. Other particular examples of suitable terminal groups include alkyls with 1-18 carbon atoms in addition to other unsaturated hydrocarbon variants, such as, aryl, aralkyl, alkenyl, and alkenyl-aryl. Additionally, materials with amine terminations, as well as carbon oxygen functional groups such as ketones and alcohols, will exhibit oleophilic properties.

The phrase “oleophobic SAM” and variations thereof as used herein refers to a SAM having an oleophobic functional end group, such as halosilanes and alkylsilanes. Particular examples of suitable halosilane and alkylsilane terminal groups include fluorinated and perfluorinated. In some implementations, an oleophobic SAM is also hydrophobic, thus being amphiphobic.

The precursor compound for forming the SAM coating on the piece of processing equipment contains molecules having a head group and a tail with a functional end group. Common head groups include thiols, silanes with hydrolizable reactive groups (e.g., halides: {F, Cl, Br, I}, and alkoxys: {methoxy, ethoxy, propoxy}, phosphonates, etc. Common tail groups include alkyls with 1-18 carbon atoms in addition to other unsaturated hydrocarbon variants, such as, aryl, aralkyl, alkenyl, and alkenyl-aryl. In addition, the hydrocarbons materials listed above can be functionalized with fluorine substitutions, amine terminations, as well as carbon oxygen functional groups such as ketones and alcohols, etc., depending on the desired properties of the resulting SAM coating. SAMs are created by chemisorption of the head groups onto the substrate material (i.e., in this application, onto the piece of processing equipment) from either a vapor or liquid phase, by processes such as immersion or dip coating, spraying, chemical vapor deposition (CVD), micro-contact printing, dip-pen nanolithography, ink-jet printing, etc. The head groups closely assemble on the material with the tail groups extending away from the material. The self-assembled monolayer can be, for example, an organosilane (e.g. alkyl trichlorosilane, fluorinated alkyl trichlorosilane, alkyl trialkyloxysilane, fluorinated alkyl trialkyloxysilane, etc.).

The precursor compound of the SAM may be present in any conventionally-used organic solvent, inorganic solvent, water, or any mixture thereof. Examples of suitable organic solvents may include, but are not limited to, alcohols (e.g., methyl alcohol, ethyl alcohol, n-propyl alcohol, isopropyl alcohol, n-butyl alcohol, sec-butyl alcohol, t-butyl alcohol, isobutyl alcohol, and diacetone alcohol); ketones (e.g., acetone, methylethylketone, methylisobutylketone); glycols (e.g., ethyleneglycol, diethyleneglycol, triethyleneglycol, propyleneglycol, butyleneglycol, hexyleneglycol, 1,3-propanediol, 1,4-butanediol, 1,2,4-butantriol, 1,5-pentanediol, 1,2-hexanediol, 1,6-haxanediol); glycol ethers (e.g., ethyleneglycol dimethyl ether, and triethyleneglycol diethyl ether); glycol ether acetates (e.g., propylene glycol monomethyl ether acetate (PGMEA)); acetates (e.g., ethylacetate, butoxyethoxy ethyl acetate, butyl carbitol acetate (BCA), dihydroterpineol acetate (DHTA)); terpineols (e.g., trimethyl pentanediol monoisobutyrate (TEXANOL)); dichloroethene (DCE); chlorobenzene; and N-methyl-2-pyrrolidone (NMP).

The concentration of the precursor compound in the solution may be determined by those skilled in the art according to the intended applications and purposes and may be in the range of about 5 to about 20 mM. An immersion step may be performed without particular limitation and may be carried out at room temperature for about 20 to 120 minutes. Alternately, other methods may be used.

An example of a commercially available low surface energy SAM is 1H,1H,2H,2H-perfluorodecyltrichlorosilane (also known as, heptadecafluoro-1,1,2,2-tetrahydro-decyl-1-trichlorosilane) [CAS: 78560-44-8], of course, other low surface energy SAM materials could be used. In general the class of fluorinated organosilane derivatives would work as low energy SAM materials. Other examples of commercially available low surface energy SAMs include: trifluoropropyltrimethoxysilane, heneicosafluorododecyltrichlorosilane, nonafluorohexyltrimethoxysilane, methyltrichlorosilane, ethyltrichlorosilane, propyltrimethoxysilane, hexyltrimethoxysilane, n-octyltriethoxysilane, n-decyltrichlorosilane, dodecyltrichlorosilane, and octadecyltrichlorosilane.

An example of a commercially available high surface energy SAM is (3-aminopropyl)-trimethoxysilane [CAS: 13822-56-5]. Of course, other high surface energy SAM materials could be used. The general class of organosilanes with amine, alcohol, or mercapto substituents would provide for a high surface energy SAM, relative to the above. Some commercially available examples include: (3-Mercaptopropyl)trimethoxysilane, methyl 11-[dichloro(methyl)silyl]undecanoate, acetoxyethyltrichlorosilane, and vinyltriethoxysilane.

Examples of commercially available oleophilic SAM materials fall within the general class of 1-18 carbon alkylsilanes with a hydrolyzable reactive group (e.g., F, Cl, Br, and I) and alkoxys (e.g., methoxy, ethoxy, and propoxy). Such chemicals are readily available, for example, from Gelest and Sigma Aldrich, and include methyltrichlorosilane, ethyltrichlorosilane, propyltrimethoxysilane, hexyltrimethoxysilane, n-octyltriethoxysilane, n-decyltrichlorosilane, dodecyltrichlorosilane, and octadecyltrichlorosilane. In addition to the alkyl class, other functional SAMs, such as the following, are also are advantageous: 3-aminopropyltrimethoxysilane, methyl 11-[dichloro(methyl)silyl]undecanoate, acetoxyethyltrichlorosilane, vinyltriethoxysilane, and nonafluorohexyltrimethoxysilane.

Various oleophobic SAM materials are commercially available and suitable for use on pieces of processing equipment.

As indicated above, by coating at least one piece of processing equipment with SAM, contaminants in the assembled disc drive assembly are reduced, due to less or no contaminants being transferred to the components of the disc drive from the processing equipment. For example, a hydrophobic SAM coating on a piece of processing equipment will inhibit particles from sticking to the coated piece; an oleophobic SAM coating will inhibit lubricant and other oil-based materials from adhering to and/or wetting the coated piece. With less contaminants available to be transferred to the components, results in less contaminants in the assembled disc drive.

In some implementations, a base or seed layer may be applied to the piece of processing equipment prior to applying the SAM coating. A base or seed layer may be included to improve the adhesion and/or orientation of the SAM coating to the piece, particularly when the piece has a surface material typically not amenable to SAM formation, or to provide additional or different properties to the piece. For example, plastic pieces are known to off-gas, particularly if a plasticizer is present in the plastic. A base or seed layer may seal the piece, inhibiting of contamination (e.g., plasticizer) from originating from the plastic piece. Additionally, plastic pieces are typically not amenable to SAM reaction and formation due to low oxide content of the material; a base or seed layer can be tailored to make the plastic piece a better substrate for SAM formation. Additionally or alternately, a base or seed layer may provide thermal stability to the SAM coating. Additionally or alternately, a base or seed layer may act as a barrier layer to inhibit transport of humidity and solvent vapors to and from the processing equipment. Still further, a base or seed layer on a metal processing piece may be corrosion resistant. Examples of suitable base or seed layers include oxides (e.g., metal oxides). Of course, a base or seed layer may provide other benefits.

Various implementations of a self-assembled monolayer (SAM) coating on a piece of process equipment have been described above. The SAM coating is provided on a piece of process equipment that contacts a component (e.g., slider, actuator, media, etc.) of a disc drive during manufacture and/or assembly of the component. The SAM inhibits the contact transfer of any contaminants that might be on the piece of process equipment to the component, either by inhibiting the presence of the contaminant on the piece or by inhibiting release of the contaminant from the piece. The SAM is not found in the eventual assembled disc drive assembly.

The above specification provides a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about.” Accordingly, unless indicated to the contrary, any numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the recited claims.

What is claimed is:

1. A method of making a disc drive assembly comprising a plurality of components, the method comprising providing a self-assembled monolayer coating on at least one piece of process equipment that contacts at least one of the plurality of components.

2. The method of claim 1, wherein component is a slider and the piece of process equipment is one that contacts the slider during manufacture of the slider.

3. The method of claim 1, wherein the piece of process equipment is a slider tray.

4. The method of claim 1, wherein the piece of process equipment is a jig used to assemble the slider with a head-gimbal assembly.

5. The method of claim 1, wherein the piece of process equipment is one that contacts a head-gimbal assembly.

6. The method of claim 1, wherein the component is a media disc and the piece of process equipment is a media carrier.

7. The method of claim 1, wherein the component is a disc drive housing.

8. The method of claim 1, wherein the piece of process equipment is plastic.

9. The method of claim 8, comprising providing a seed layer on the plastic piece of process equipment, with the self-assembled monolayer coating on the seed layer.

10. The method of claim 1, wherein the piece of process equipment contacts a wafer from which sliders are formed.

11. The method of claim 1, wherein the piece of process equipment contacts a subpart of a wafer from which sliders are formed.

12. A method comprising inhibiting contact transfer from a piece of process equipment to a component of a disc drive assembly by providing a self-assembled monolayer coating on the piece of process equipment.

13. The method of claim 12, wherein the piece of process equipment is one that contacts the slider during manufacture of the slider.

14. The method of claim 12, wherein the piece of process equipment is a slider tray.

15. The method of claim 12, wherein the piece of process equipment is one that contacts a head-gimbal assembly.

16. The method of claim 12, wherein the piece of process equipment is a media carrier.

17. The method of claim 12, wherein the piece of process equipment is plastic.

18. The method of claim 17, comprising providing a seed layer on the plastic piece of process equipment, with the self-assembled monolayer coating on the seed layer.

19. The method of claim 12, wherein the piece of process equipment contacts a wafer from which sliders are formed.

20. The method of claim 12, wherein the piece of process equipment contacts a subpart of a wafer from which sliders are formed.

21. A piece of process equipment that contacts a component of a disc drive assembly during manufacture of the component or the disc drive assembly, the piece of process equipment comprising thereon a self-assembled monolayer coating.

22. The piece of process equipment of claim 21 further comprising a seed layer between the piece and the self-assembled monolayer coating.
